(19) United States
(12) Patent Application Publication
(10) Pub. No.: US 2006/0259800 A1
(43) Pub. Date: Nov. 16, 2006

(54) Circuit system

(75) Inventor: Hideo Maejima, Kawasaki-shi (JP)

Correspondence Address: STAAS & HALSEY LLP, SUITE 700, 1201 NEW YORK AVENUE, N.W., WASHINGTON, DC, 20005, US

(73) Assignee: SEMICONDUCTOR TECHNOLOGY ACADEMIC RESEARCH CENTER, Yokohama (JP)

(21) Appl. No.: 11/412,948

(22) Filed: Apr. 28, 2006

(30) Foreign Application Priority Data
May 16, 2005 (JP) 2005-142747

(51) Int. Cl. G06F 1/00

(52) U.S. Cl. 713/300

(57) ABSTRACT

A circuit system, capable of further reducing power consumption without degrading performance, has been disclosed and comprises a plurality of circuit units, a power supply for supplying a plurality of power supplies of different voltages, a plurality of power supply selection circuits provided in accordance with each of the plurality of circuit units and selecting a power supply to be supplied to each circuit unit out of the plurality of power supplies of different voltages, and a control circuit for controlling the plurality of power supply selection circuits to select a power supply to be supplied to each circuit unit in accordance with the respective operation states of the plurality of circuit units, wherein each circuit unit uses a power supply selected by the power supply selection circuit as an internal power supply.

### BACKGROUND OF THE INVENTION

The present invention relates to a circuit system comprising a control circuit having a master processor etc. and a plurality of circuit units each having a slave processor and, more particularly, to a technique for reducing the power consumption, without degrading the performance, of a circuit system.

Recently, the demand for an improved processing performance of a circuit system such as a CPU of a computer has increased. In accordance with this, a multiprocessor system mounting a plurality of circuit units such as CPUs is widely employed. For example, a multiprocessor system comprises a master processor, a plurality of slave processors, and buses for connecting the master processor and the plurality of slave processors. The master processor controls the total processing and assigns complex processing to each slave processor. Each slave processor performs assigned processing and sends the processing result to the master processor. The master processor integrates the processing results sent from the respective slave processors and performs total processing.

It is important for a circuit system used in a mobile information terminal such as a mobile phone to consume less power. Because of this, such a circuit system is required to have a reduced power consumption without any degradation in performance.

As a method for reducing power consumption in the above-mentioned circuit system, three main methods are known. The first is a method for terminating power supply to a portion not in operation in a circuit system. Japanese Unexamined Patent Publication (Kokai) No. 2002-236527 describes a configuration for terminating power supply to a slave processor not in operation in a multiprocessor system.

The second is a method for reducing the clock frequency. In general, the power consumption of a CMOS integrated circuit varies in proportion to the frequency of a clock signal. However, if the clock frequency of a circuit system is reduced, the performance is accordingly degraded. Therefore, the operation state of a circuit system is monitored and when the operation speed may be slow, the clock frequency is reduced.

The third is a method for reducing the power supply voltage. However, if the power supply voltage is reduced, it is not possible to operate a circuit system at a high clock frequency, therefore, the clock frequency must be reduced in accordance with the drop in the power supply voltage and the performance is accordingly degraded. Therefore, the operation state of a circuit system is monitored and when the operation speed may be slow, the power supply voltage is reduced.

International Publication WO 02/50645A1 describes a method for adjusting a power supply voltage and a clock frequency to be supplied to an electronic circuit by monitoring the operation state of the electronic circuit.

Japanese Unexamined Patent Publication (Kokai) No. 2004-78940 describes setting of optimized power supply voltage and clock frequency in accordance with required performance of each processor for each plurality of circuit units constituting a circuit system in, for example, a multiprocessor system.

### SUMMARY OF THE INVENTION

In the multiprocessor system described in Japanese Unexamined Patent Publication (Kokai) No. 2004-78940, the power supply voltage and the clock frequency of each processor are optimized in accordance with required performance, however, this setting is performed manually and the set state is maintained until it is modified. In other words, the kind of processing to be assigned to each processor is determined in advance and, by estimating the load in accordance with the kind of processing, the power supply voltage and the clock frequency of each processor are determined in accordance with the estimated load.

However, when a multiprocessor is actually operated, the contents of processing by each processor vary in accordance with processing to be performed and the load of each processor also varies accordingly. Because of this, the set power supply voltage and clock frequency of each processor differ from the optimized power supply voltage and clock frequency when actual processing is performed. Further, the optimized power supply voltage and clock frequency when actual processing is performed can vary at any time in accordance with the contents of processing, therefore, with the configuration according to the patent document 3, the power supply voltage and the clock frequency of each processor are set to reasonable conditions in most cases but it is impossible to cope with optimized conditions that vary.

Although Japanese Unexamined Patent Publication (Kokai) No. 2004-78940 describes setting the power supply voltage and the clock frequency for each processor, it does not describe input/output of signals of the power supply voltage and the clock frequency that differ from processor to processor.

The electronic circuit described in International Publication WO 02/50645A1 monitors the operation state and totally adjusts the power supply voltage and the clock frequency to be supplied to the electronic circuit. However, in order to perform adjustment without degrading the performance of the electronic circuit with this method, it is necessary to adjust the power supply voltage and the clock frequency to those required by a portion that requires the highest speed in the electronic circuit and, therefore, the high voltage power supply and the high frequency clock, not necessary to other portions, are supplied and power is consumed in wasteful manner, as a result.

An object of the present invention is to solve the above-mentioned problems and to realize a circuit system capable of further reducing power consumption without degrading performance.

FIG. 1 is a diagram showing a fundamental configuration of a circuit system of the present invention.

In order to attain the above-mentioned objects, as shown in FIG. 1, in a circuit system of the present invention comprising a plurality of circuit units 1A, 1B, 1C, . . . , a power supply 2 of a plurality of different voltages is provided and each unit selects one of the power supply voltages as its internal power supply so as to meet the required performance and sets a clock frequency suited to the selected power supply voltage. In other words, it is made possible for each of the plurality of circuit units to be capable of setting an arbitrary combination of a power supply voltage and a clock frequency and attaining most effective reduction in power consumption, at the time, in accordance with the operation state of each circuit unit.

In other words, the circuit system of the present invention is characterized by comprising the plurality of circuit units 1A, 1B, 1C, . . . , the power supply 2 for supplying a plurality of different voltage power supplies, a plurality of power supply selection circuits 3A, 3B, 3C, . . . , provided in accordance with each of the plurality of circuit units and selecting a power supply to be supplied to each circuit unit from the plurality of different voltage power supplies, and a control circuit 4 for controlling the plurality of power supply selection circuits to select a power supply to be supplied to each circuit unit in accordance with the operation state of each of the plurality of circuit units, wherein each unit uses the power supply selected by the power supply selection circuit as its internal power supply.

With the circuit system of the present invention, it is possible to set an internal voltage for each unit and an optimized power supply voltage is set in accordance with the operation (load) state of each circuit unit and, therefore, it is possible to reduce power consumption without degrading performance.

The circuit system of the present invention can be provided on one chip, however, this is not a limitation.

The power supply is provided inside or outside of a chip on which the circuit system is provided. The power supply comprises a reference power supply generation circuit for generating a reference power supply and an auxiliary power supply generation circuit for generating at least one auxiliary power supply different from the voltage of the reference power supply, and an internal power supply is selected from the reference power supply and the at least one auxiliary power supply provided to the power supply selection circuit of each circuit unit.

As there can arise a case where the internal power supply voltage in each circuit unit differs from each another, each circuit unit is provided with a level conversion circuit for converting so that the voltage levels coincide for an outside signal and an internal signal. The external signal is a signal based on the reference power supply and the reference power supply is provided to each circuit unit separately from the power supply supplied to the power supply selection circuit. The level conversion circuit is supplied with the reference power supply and the internal power supply.

In other words, each circuit unit comprises a first level conversion circuit for converting an external signal having the reference power supply voltage into an internal signal having the internal power supply voltage and a second level conversion circuit for converting an internal signal having the internal power supply voltage into an external signal having the reference power supply voltage.

It is preferable for the auxiliary power supply generation circuit to be a multi-voltage power supply circuit capable of generating power supplies of different voltages. Due to this, it possible to more precisely control the internal power supply of each circuit unit.

As described above, it is preferable to control not only the power supply voltage of each circuit unit but also the clock frequency.

Therefore, the circuit system comprises a clock generation circuit for generating a plurality of clocks of different periods and a plurality of clock selection circuits provided in accordance with each of the plurality of circuit units and selecting a clock to be supplied to each circuit unit from the plurality of clocks, wherein the control circuit controls each clock selection circuit to select a clock to be supplied to each circuit unit in accordance with the operation state of each of the plurality of circuit units and the power supply to be supplied.

The clock generation circuit comprises a reference clock generation circuit for generating a reference clock and an auxiliary clock generation circuit for generating at least one auxiliary clock different in period from the reference clock and it is preferable for the reference clock to be supplied to all of the plurality of circuit units. The auxiliary clock generation circuit is provided in accordance with each of the plurality of circuit units and the auxiliary clock generation circuit comprises a division circuit for generating an auxiliary clock by dividing the reference clock.

The present invention is applied to a multiprocessor comprising a master processor and a plurality of slave processors, wherein the master processor controls assignment of processing to each slave processor. The control circuit has a master processor and a control register and each circuit unit is configured so as to have a slave processor. The master processor is able to know the load state of each slave processor by analyzing processing to be assigned to each slave processor and determine a power supply voltage and a clock frequency necessary for that. Then, a value in accordance with the determined power supply voltage and clock frequency of each slave processor is written into the control register and the output of the control register controls the power supply selection circuit and clock selection circuit in accordance with each circuit unit.

### BRIEF DESCRIPTION OF THE DRAWINGS

The features and advantages of the invention will be more clearly understood from the following descriptions taken in conjunction with the accompanying drawings in which:

FIG. 1 is a diagram showing a fundamental configuration of a circuit system of the present invention;

FIG. 2 is a diagram showing a configuration of a multiprocessor system in an embodiment of the present invention;

FIG. 3 is a diagram showing a configuration of a slave processor;

FIG. 4 is a diagram showing a configuration of a power supply selection circuit;

FIG. 5 is a diagram showing a configuration of a level conversion circuit;

FIG. 6A is a diagram showing a configuration of a level down circuit;

FIG. 6B is a diagram showing a configuration of a level up circuit;

FIG. 7 is a diagram showing a configuration of a clock division circuit;

FIG. 8 is a diagram showing a configuration of a control unit;

FIG. 9 is a diagram showing a configuration of a multi-voltage power supply circuit;

FIG. 10 is a diagram for explaining the operation of a multiprocessor system in an embodiment;

FIG. 11A is a diagram showing a relationship between the internal power supply voltage and a possible clock frequency in a slave processor;

FIG. 11B is a diagram showing a control code of clock frequency selection in the multi-voltage power supply circuit;

FIG. 11C is a diagram showing a control code of clock frequency selection in a clock division circuit 35;

FIG. 12A to FIG. 12D are diagrams showing examples of control states; and

FIG. 13A to FIG. 13D are diagrams showing other examples of control states.

### DESCRIPTION OF THE PREFERRED EMBODIMENTS

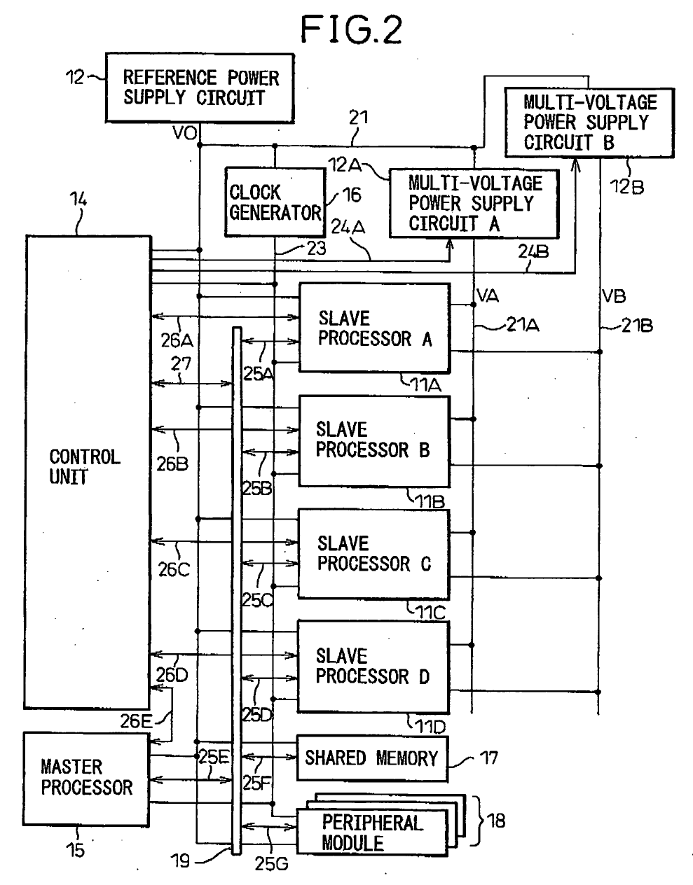

FIG. 2 is a diagram showing a configuration of a multiprocessor system in an embodiment of the present invention. As shown in FIG. 2, the multiprocessor system in the present embodiment comprises a master processor 15, four slave processors 11A to 11D, a reference power supply circuit 12, two multi-voltage power supply circuits 12A and 12B, a control unit 14, a clock generation circuit 16, a shared memory 17, and a peripheral module 18. In the present embodiment, the portions excluding the reference power supply circuit 12 and the two multi-voltage power supply circuits 12A and 12B are mounted on one chip. However, the present invention is not limited to this and it may also be possible for the reference power supply circuit 12 and the two multi-voltage power supply circuits 12A and 12B to be mounted on a chip or the two multi-voltage power supply circuits 12A and 12B to be mounted on a chip or not on a chip.

The reference power supply 12 generates a power supply of a reference voltage V0 and supplies it to all of the circuits via a power supply line 21. The multi-voltage power supply circuit 12A generates a plurality of power supplies of voltages from the power supply of the reference voltage V0 and supplies a power supply of a voltage VA directed by a control signal from the control unit 14 via a signal line 24A to a power supply line 21A. Similarly, the multi-voltage power supply circuit 12B also generates a plurality of power supplies of voltages from the power supply of the reference voltage V0 and supplies a power supply of a voltage VB directed by a control signal from the control unit 14 via a signal line 24B to a power supply line 21B. The clock generation circuit 16 generates a reference clock having a frequency 2f and supplies it via clock signal line 23 to the master processor 15, the four slave processors 11A to 11D, the control unit 14, the shared memory 17, and the peripheral module 18. The master processor 15, the four slave processors 11A to 11D, the control unit 14, the shared memory 17, and the peripheral module 18 are capable of transmitting and receiving data between each other via buses 19 and 25A to 25G. The control unit 14 is connected to the master processor 15 via a signal line 26E and to the four slave processors 11A to 11D via signal lines 26A to 26D, respectively. In the present embodiment, a voltage of the internal power supply of the four slave processors 11A to 11D can be selected, however, at the interface portion between other components, a signal having a voltage level in accordance with the reference voltage V0 is used. Here, explanation is given on the assumption that the reference voltage V0 is the highest voltage, however, the reference voltage V0 may be the lowest or intermediate.

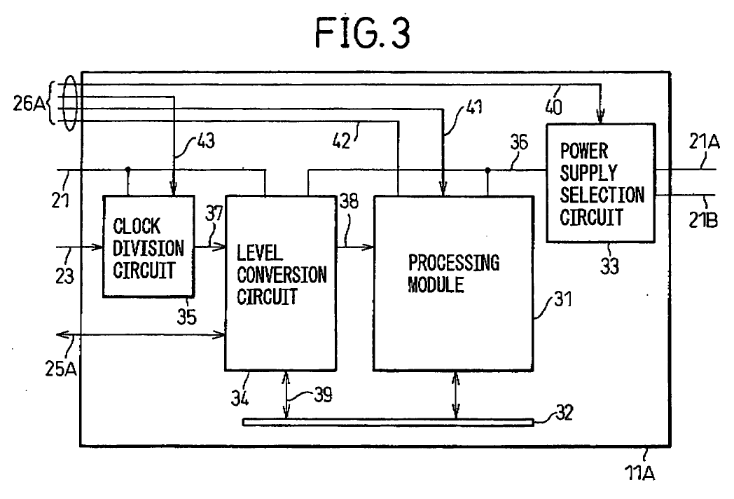

FIG. 3 is a diagram showing the configuration of the slave processor 11A and other slave processors 11B to 11D have the same configuration. The slave processor 11A comprises a processing module 31, an internal bus 32, a power supply selection circuit 33, a level conversion circuit 34, and a clock division circuit 35. The processing module 31 may further comprise a plurality of modules.

The signal line 26A to and from the control unit 14 branches into a signal line 40 for a power supply selection signal for controlling the power supply selection circuit 33, signal lines 41 and 42 for interruption processing, and a signal line 43 for a clock selection signal for controlling the clock division circuit 35.

The power supply selection circuit 33 selects either of the power supply lines 21A and 21B from the multi-voltage power supply circuit 12A and the multi-voltage power supply circuit 12B to connect it to an internal power supply line 36.

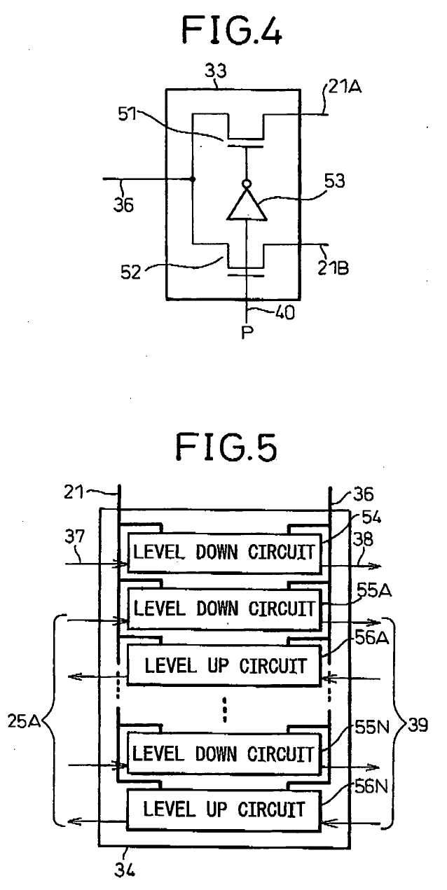

FIG. 4 is a diagram showing the circuit configuration of the power supply selection circuit 33. The power supply selection circuit 33 has MOS switches 51 and 52 for selecting either of the power supply lines 21A and 21B from the multi-voltage power supply circuit 12A and the multi-voltage power supply circuit 12B and an inverter 53 for putting one of the MOS switches 51 and 52 into the on state and the other into the off state in accordance with a power supply selection signal. When the power supply selection signal is “0”, that is, “L”, the power supply line 21A is connected to the internal power supply line 36 and when the power supply selection signal is “1”, that is, “H”, the power supply line 21B is connected to the internal power supply line 36. Although not shown in FIG. 3 or FIG. 4, the power supply of the inverter 53 is supplied from the power supply line 21. This is because the voltage of the power supply to be supplied to the power supply line 21 is highest and to avoid the drop in voltage in the MOS switches 51 and 52 when the voltage of the power supply lines 21A and 21B is transferred to the internal power supply line 36. Here, the circuit configuration is such that either of the MOS switches 51 and 52 is turned on, however, it may also possible to provide a control circuit for turning off both the MOS switches 51 and 52 in order not to supply power to the slave processor.

Returning to FIG. 3, the internal power supply selected by the power supply selection circuit 33 is supplied to the processing module 31 and the level conversion circuit 34 via the internal power supply line 36. The reference power supply line 21 from the reference power supply circuit 12 in FIG. 2 is connected to the level conversion circuit 34 and the clock division circuit 35. Therefore, both the reference power supply and the internal power supply are supplied to the level conversion circuit 34.

The power supply to be supplied to the processing module 31 of the slave processor 11 is the internal power supply. In contrast to this, as described above, the signal to be input from the outside of the slave processor 11 is a signal based on the reference power supply, therefore, the voltage level is different and it is necessary to convert it into a signal having the voltage level of the internal power supply. Further, it is also necessary to convert a signal to be output from the slave processor 11 from a signal based on the internal power supply into a signal based on the reference power supply. The level conversion circuit 34 performs this conversion.

FIG. 5 is a diagram showing the configuration of the circuit of the level conversion circuit 34. The level conversion circuit 34 has a level down circuit 54 for converting the level of a selection clock to be output to a clock signal line 37 from the clock division circuit 35 into a signal having the level of the internal power supply, level down circuits 55A, . . . , 55N for converting an input signal to be input to the slave processor 11 via the buses 19 and 25A into a signal having the level of the internal power supply, and level up circuits 56A, . . . , 56N for converting a signal having the level of the internal power supply to be output from the slave processor 11 via the internal bus 32 and an internal bus 39 into an output signal based on the reference power supply. By the way, the level down circuits 55A, . . . , 55N perform outputting only when a data signal is input to the slave processor 11 and at other times, the output enters a high impedance state. Similarly, the level up circuits 56A, . . . , 56N perform outputting only when a data signal is input from the slave processor 11 and at other times, the output enters a high impedance state.

In FIG. 5, the reference voltage is the highest level, therefore, an external signal is converted into an internal signal in the level down circuit and an internal signal is converted into an external in the level up circuit, however, in the case where the reference voltage is the lowest level, the configuration will be opposite.

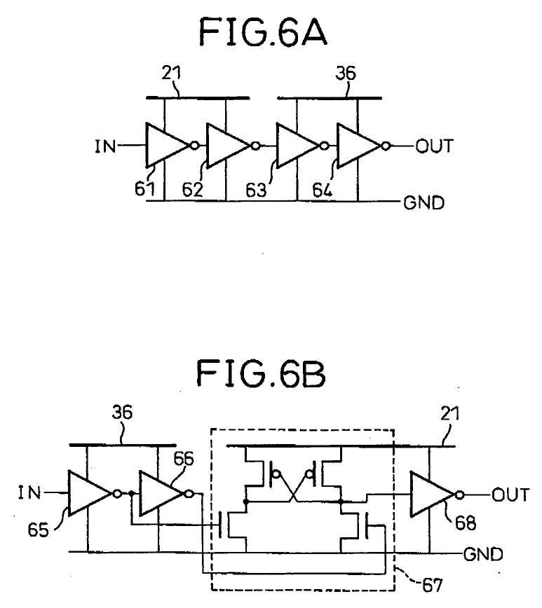

FIG. 6A shows a configuration example of the level down circuit and FIG. 6B shows a configuration example of the level up circuit.

As shown in FIG. 6A, in the level down circuit, an input signal IN based on the high level reference power supply is input to two inverters 61 and 62 supplied with power supply from the reference power supply line 21 and connected in series. The output of the inverter 62 is input to two inverters 63 and 64 supplied with power supply from the internal power supply line 36 and connected in series and converted into an output OUT based on the low level internal power supply.

As shown in FIG. 6B, in the level up circuit, an input signal IN based on the low level reference power supply is input to two inverters 65 and 66 supplied with power supply from the internal power supply line 36 and connected in series. The outputs of the inverters 65 and 66 are applied to the gates of a pair of MOSFETS that are included in a step-up circuit 67 supplied with power supply from the reference power supply line 21. The output of the step-up circuit 67 is input to an inverter 68 supplied with power supply from the reference power supply line 21 and inverted into an output OUT based on the high level reference power supply.

Returning to FIG. 2 and FIG. 3, a reference clock generated by the clock generator 16 is supplied to the clock division circuit 35 of the slave processor 11 via the-clock signal line 23. The clock division circuit 35 divides the reference clock having a frequency 2f and generates clock signals having frequencies f, f/2, f/4, and f/8 and outputs a clock signal having any one of the four frequencies in accordance with the clock selection signal to be input from the control circuit 14 via the signal line 43.

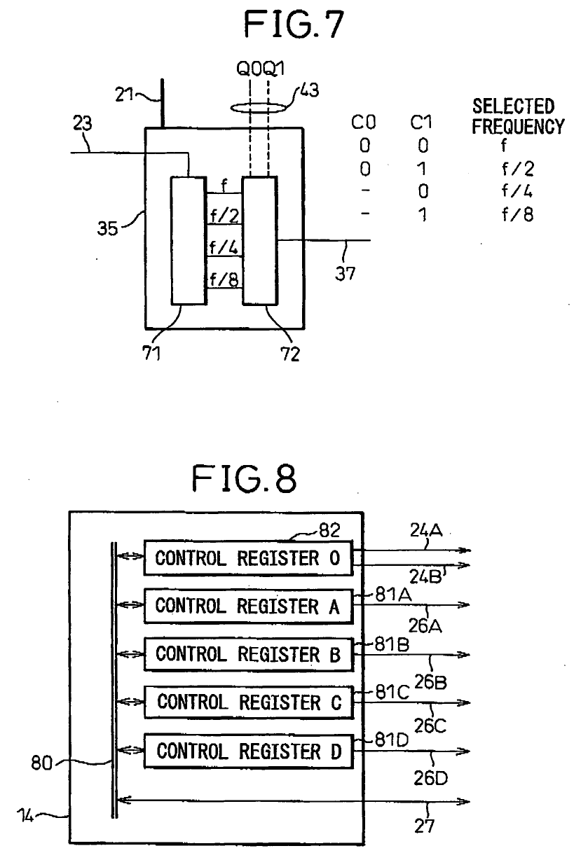

FIG. 7 is a diagram showing the configuration of the clock division circuit 35. As shown in FIG. 7, the clock division circuit 35 is a circuit that operates on the reference power supply and has a division counter 71 for dividing the reference clock having a frequency 2f and a clock selection circuit 72 that selects one clock signal out of four clock signals having frequencies f, f/2, f/4, and f/8 generated by the division counter 71 in accordance with two-bit clock selection signals Q0 and Q1 to be input via the signal line 43 and outputs it as a selection clock. The values of the clock selection signals Q0 and Q1 and the frequencies of the clock signal to be selected are as shown schematically. The selection clock is input to the level conversion circuit 34 via the signal line 37 and its level is converted.

By the way, if the number of bits of the clock selection signal is increased and the division counter 71 and the clock selection circuit 72 are extended accordingly, it is made possible to increase the range of clock selection. Further, if a mode that selects no clock is provided, it is also possible to provide a sleep mode that stops the supply of a clock.

The selection of the internal power supply and the selection of-the internal clock in each slave processor are controlled by the data written into the register in the control unit 14. Further, as will be described later, the selection of the voltage of the power supply to be output from the multi-voltage power supply circuits 12A and 12B is also controlled by the data written into the register in the control unit 14.

FIG. 8 is a diagram showing the configuration of the control unit 14. As shown schematically, the control unit 14 has control registers 81A to 81D corresponding to the slave processors 11A to 11D and a control register 82 corresponding to the multi-voltage power supply circuits 12A and 12B. The control registers 81A to 81D and 82 are capable of performing writing from the master processor 15 via an internal bus 80, a bus 27, and the external bus 19. The control registers 81A to 81D output a power supply selection signal P to be applied to the power supply selection circuit 33 of the slave processors 11A to 11D and the clock selection signals Q0 and Q1 of the clock selection circuit 35. The control register 82 outputs a signal for selecting a power supply voltage to be output from the multi-voltage power supply circuits 12A and 12B to the signal lines 24A and 24B.

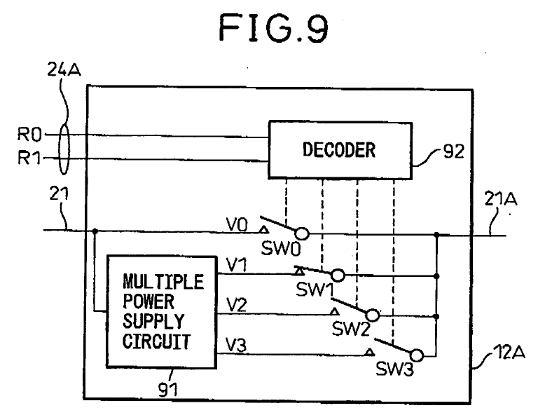

FIG. 9 is a diagram showing the configuration of the multi-voltage power supply circuit 12A and the multi-voltage power supply circuit 12B has also the same configuration. As shown schematically, the multi-voltage power supply circuit 12A is supplied with the reference power supply V0 via the power supply line 21 and has a multiple power supply circuit 91 for generating power supplies of different voltages V1, V2, and V3 lower than the reference power supply from the reference power supply, four connection switches SW0, SW1, SW2, and SW3 between the power supply line 21 and the power supply line 21A, and between the three output power supply lines of the multiple power supply circuit 91 and the power supply line 21A, and a decoder 92 for controlling the opening and closing of the four connection switches SW0, SW1, SW2, and SW3 based on power supply voltage control signals R0 and R1 supplied from the control register 82 via the signal line 24A.

It is possible to put any one of the four connection switches SW0, SW1, SW2, and SW3 into the on state to output a power supply of a selected voltage to the power supply line 21A by decoding the two-bit power supply voltage control signals R0 and R1. By the way, FIG. 9 shows a state in which the power supply voltage control signals R0 and R1 are (0, 1), the connection switch SW1 is turned on, and other connection switches are turned off.

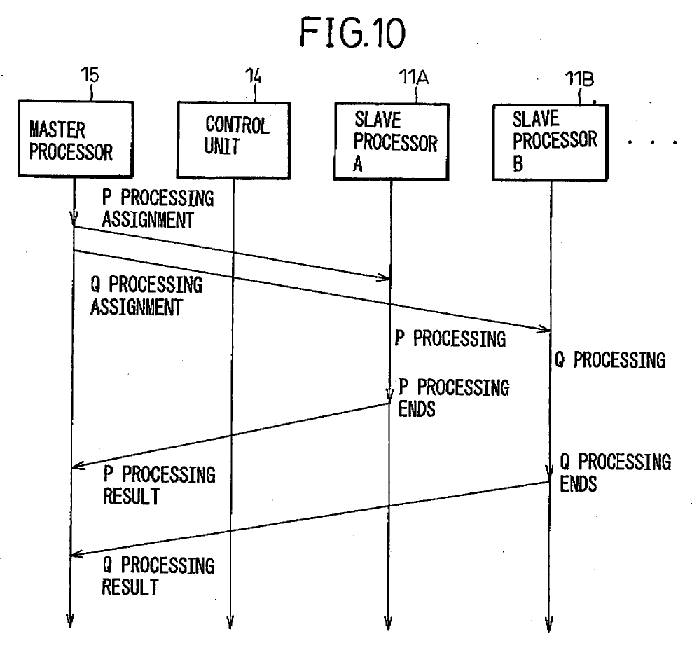

Next, the operation of the multiprocessor system in the present embodiment is explained. FIG. 10 is a diagram for explaining the processing operation of the multiprocessor system in the present embodiment, The multiprocessor 15 extracts integrated processing such as media processing, which has a large load and which requires a long time for processing, among the processing directed from the outside as a thread and sends the thread to any one of the slave processors 11A to 11D via the bus 19. The slave processor having received the thread performs processing of the thread and sends the processing result to the master processor 15 via the bus 19. It is possible for the master processor 15 to perform other processing not affected by the processing result of the thread after sending the thread and until the processing result is sent back. In FIG. 10, after a thread of P processing is sent to the slave processor 11A, a thread of other Q processing is sent to the slave processor 11B. Therefore, the slave processors 11A and 11B perform processing of the thread in parallel. FIG. 10 shows the slave processors 11A and 11B, however, it is also possible for other slave processors 11C and 11D to similarly perform processing of the thread in parallel.

The operation of assigning a thread from the master processor 15 to the slave processor and the transmission of the processing result of the thread from the slave processor to the master processor 15 are performed by interruption processing via the control circuit 14. Part of the signal lines 26A to 26E is used to transmit the interruption processing. The processing does not relate directly to the present invention and, therefore, a detailed explanation is omitted.

Either way, the master processor 15 determines the assignment of a thread to each slave processor and, therefore, it is possible to determine a power supply voltage and a clock frequency optimum for performing an assigned thread by each slave processor. For example, for a thread with a large amount of processing and which must be processed in a short time, the power supply voltage and the clock frequency of the slave processor that performs it are increased and for a thread with a small is amount of processing and for which a long time is given for processing, the power supply voltage and the clock frequency of the slave processor that performs it are decreased. By the way, even if the amount of processing of a thread is large, if the thread does not require the processing result until the processing of a thread with a large amount of processing that is being performed in parallel by other slave processor, it is only necessary to determine the power supply voltage and the clock frequency of the slave processor so that the processing is completed in the meantime. As described above, it is possible for the master processor 15 to determine a power supply voltage and a clock frequency optimum for each slave processor. It is also possible to put a slave processor, to which no thread is assigned, into the sleep mode.

The master processor 15 writes the control data of the power supply voltage and the clock frequency optimum for each slave processor into the register in the control unit 14 via the bus 19. At this time, the master processor 15 also writes the data for selecting a voltage output from the multi-voltage power supply circuits 12A and 12B in order to provide the optimum power supply voltage and clock frequency optimum to each slave processor into the register in the control unit 14. The master processor 15 monitors the thread auxiliaryjected to processing by each slave processor and rewrites the data in the register in the control unit 14 at any time. It is only necessary to perform the rewriting operation when a new thread is assigned and when the processing result of a thread is received.

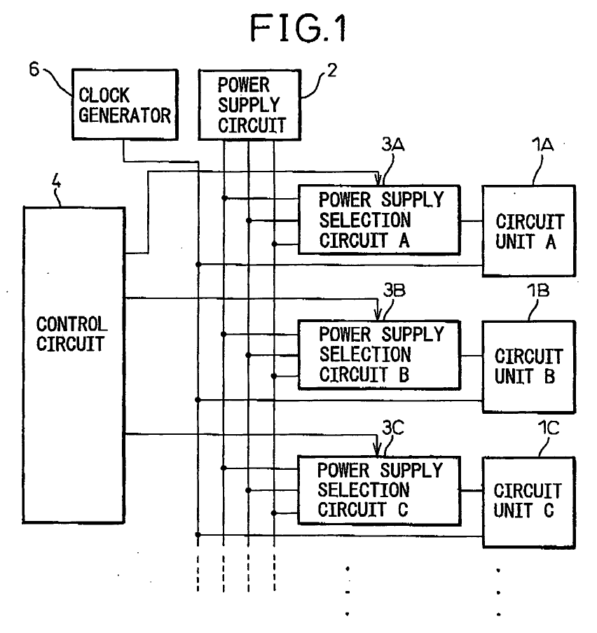

Therefore, if the multiprocessor system in the present embodiment is associated with the configuration of the circuit system in FIG. 1, the control unit 14 and the master processor 15 correspond to the control circuit 14, the reference power supply circuit 12 and the multi-voltage power supply circuits 12A and 12B correspond to the power supply circuit 2, the power supply selection circuit 33 of the slave processor corresponds to the power supply selection circuits 3A to 3C, and the slave processors A, B, and C excluding the power supply selection circuit 33 correspond to the circuit units 1A, 1B, and 1C.

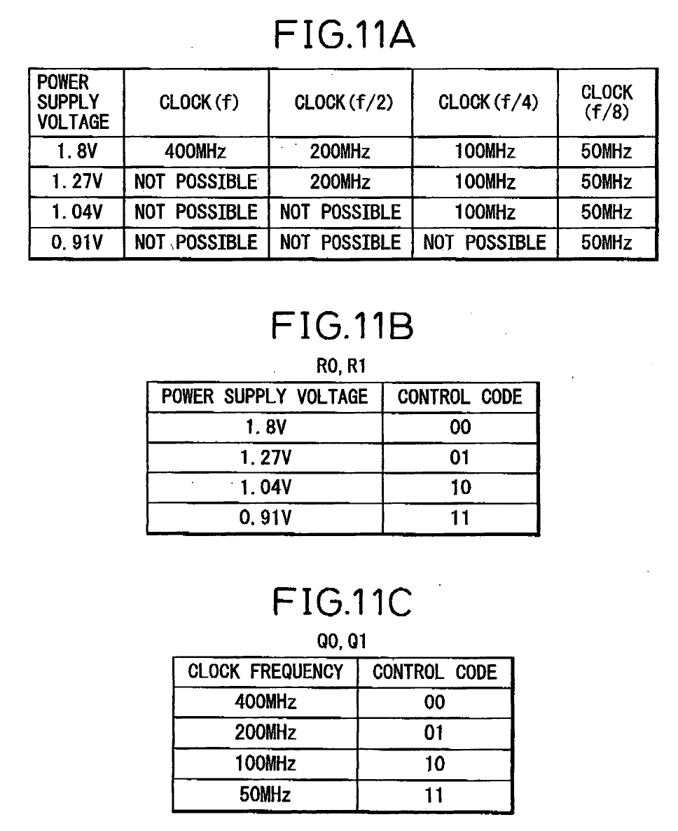

Next, an example of control in the multiprocessor system in the present embodiment is explained. FIG. 11A shows the relationship between the internal power supply voltage and the possible clock frequency in the slave processors 11A to 11D, FIG. 11B shows the relationship between the power supply voltage selected in the multi-voltage power supply circuit 12A or 12B and the control code of the power supply voltage control signals R0 and R1, and FIG. 11C shows the relationship between the clock frequency selected in the clock division circuit 35 and the control code of the clock selection signal Q0 and Q1.

As shown in FIG. 11A, when the internal power supply voltage is 1.8 V, operation is possible at every frequency up to a clock frequency of 400 MHz. When the internal power supply voltage is 1.27 V, operation is possible at every frequency up to a clock frequency of 200 MHz, however, operation is not possible at a clock frequency of 400 MHz. Similarly, when the internal power supply voltage is 1.04 V, operation is possible up to a clock frequency of 100 MHz and when the internal power supply voltage is 0.91 V, operation is possible up to a clock frequency of 50 MHz.

As shown in FIG. 11B, in order to set the voltage output from the multi-voltage power supply circuit 12A or 12B to 1.8 V, R0 and R1 are set to “0” and “0”, to set it to 1.27 V, R0 and R1 are set to “0” and “1”, to set it to 1.04 V, R0 and R1 are set to “1” and “0” R0, and to set it to 0.91 V, R0 and R1 are set to “1” and “1”.

As shown in FIG. 11C, in order to set the frequency of the internal clock to 400 MHz, Q0 and Q1 are set to “0” and “0”, to set it to 200 MHz, Q0 and Q1 are set to “0” and “1”, to set it to 100 MHz, Q0 and Q1 are set to “1” and “0”, and to set it to 50 MHz, Q0 and Q1 are set to “1” and “1”.

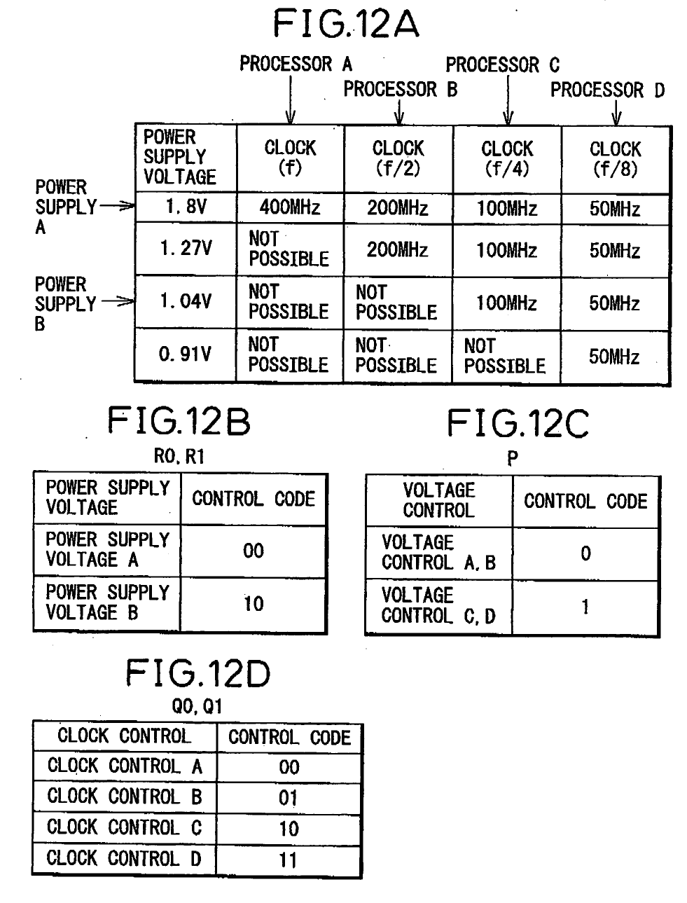

FIG. 12A to FIG. 12D are diagrams showing an example of the control state. As shown in FIG. 12A, in this state, the slave processors A to D operate at clock frequencies of 400 MHz, 200 MHz, 100 MHz, and 50 MHz, respectively. In order to realize this state, the multi-voltage power supply circuit 12A outputs a power supply of 1.8 V and the multi-voltage power supply circuit 12B outputs a power supply of 1.04 V. Then, as shown in FIG. 12B, R0 and R1 to be supplied to the multi-voltage power supply circuit 12A are set to “0” and “0” and R0 and R1 to be supplied to the multi-voltage power supply circuit 12B are set to “1” and “0”. Further, as shown in FIG. 12C, in the slave processors A and B, the power supply selection signal P is set to “0” and in the slave processors C and D, the power supply selection signal P is set to “1”. Furthermore, as shown in FIG. 12D, in the slave processor A, Q0 and Q1 are set to “0” and “0”, in the slave processor B, Q0 and Q1 are set to “0” and “1”, in the slave processor C, Q0 and Q1 are set to “1” and “0”, and in the slave processor D, Q0 and Q1 are set to “1” and “1”.

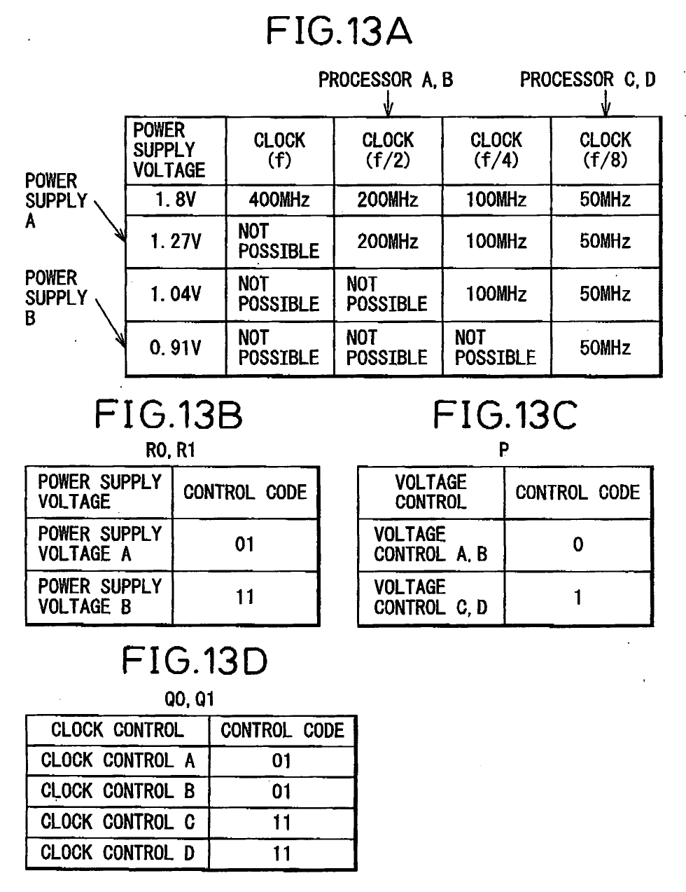

FIG. 13A to FIG. 13D are diagrams showing another example of the control state. In this state, the slave processors A and B operate at a clock frequency of 200 MHz and the slave processors C and D operate at a clock frequency of 50 MHz. In order to realize this state, R0 and R1 and P, Q0, and Q1 in each slave processor are set to the control code shown schematically.

The embodiments of the present invention are described as above, however, the present invention is not limited to the configurations exemplified above and various modification examples may be possible.

For example, in the embodiments, the control unit 14 is provided outside the slave processors 11A to 11D, however, it is also possible to provide part corresponding to each slave processor of the control unit 14 at each slave processor.

In the embodiments, the clock generation circuit 16 outputs only the reference clock, however, it is also possible to provide a division counter in the clock generation circuit 16 to cause it to output clocks of a plurality of frequencies and provide only the clock selection circuit in each slave processor.

Further, in the embodiments, the multiprocessor system is explained as an example, however, the present invention can be applied to a case where the circuit unit is not a processor.

According to the present invention, in a circuit system such as a multiprocessor comprising a plurality of processors, the power supply voltage and the clock frequency of each processor are turned into an optimum state in accordance with the operation state, therefore, it is possible to reduce power consumption without degrading performance.

The circuit system of the present invention is capable of reducing power consumption in accordance with the operation state without degrading performance and, therefore, it can be used widely in a mobile information terminal such as a mobile phone for which operation with low power consumption and high performance are required.

We claim:

1. A circuit system comprising:
a plurality of circuit units;
a power supply for supplying a plurality of power supplies of different voltages;
a plurality of power supply selection circuits provided in accordance with each of the plurality of circuit units and selecting a power supply to be supplied to each circuit unit from the plurality of power supplies of different voltages; and
a control circuit for controlling the plurality of power supply selection circuits to select a power supply to be supplied to each circuit unit in accordance with the respective operation states of the plurality of circuit units, wherein:
each circuit unit uses a power supply selected by the power supply selection circuit as an internal power supply.

2. The circuit system as set forth in claim 1, wherein the power supply comprises:
a reference power supply generation circuit for generating a reference power supply; and
an auxiliary power supply generation circuit for generating at least one auxiliary power supply having a voltage different from the reference power supply, wherein:
the reference power supply is supplied to each of the plurality of circuit units.

3. The circuit system as set forth in claim 2, wherein each circuit unit comprises;
a first level conversion circuit for converting an external signal having the voltage of the reference power supply into an internal signal having the voltage of an internal power supply; and
a second level conversion circuit for converting an internal signal having the voltage of an internal power supply into an external voltage having the voltage of the reference power supply.

4. The circuit system as set forth in claim 2, wherein:
the auxiliary power supply generation circuit is a multi-voltage power supply circuit capable of generating a power supply of different voltage by the control of the control circuit; and
the control circuit selects a power supply to be supplied to each circuit unit by controlling the voltage of the power supply generated by the auxiliary power supply generation circuit and the plurality of power supply selection circuits.

5. The circuit system as set forth in claim 1, comprising:
a clock generation circuit for generating a plurality of clocks of different periods; and
a plurality of clock selection circuits provided in accordance with each of the plurality of circuit units and selecting a clock to be supplied to each circuit unit out of the plurality of clocks, wherein:
the control circuit controls the plurality of clock selection circuits to select a clock to be supplied to each circuit unit in accordance with the respective operation states of the plurality of circuit units and a power supply to be supplied.

6. The circuit system as set forth in claim 5, wherein:
the clock generation circuit comprises a reference clock generation circuit for generating a reference clock and an auxiliary clock generation circuit for generating at least one auxiliary clock having a period different from the reference clock; and
the reference clock is supplied to each of the plurality of circuit units.

7. The circuit system as set forth in claim 6, wherein the auxiliary clock generation circuit is provided in accordance with each of the plurality of circuit units.

8. The circuit system as set forth in claim 7, wherein the auxiliary clock generation circuit comprises a division circuit for generating the auxiliary clock by dividing the reference clock.

9. The circuit system as set forth in claim 4, wherein:
the control circuit has a master processor and a control register;
each of the plurality of circuit units has a slave processor;
the master processor controls assignment of processing to each slave processor, determines a power supply voltage to be supplied to each slave processor and an operation clock of each slave processor in accordance with the load state of each slave processor due to the load of the assigned processing, and writes a value in accordance with the determined power supply voltage and operation clock into the control register; and
the output of the control register controls the power supply selection circuit and the clock selection circuit in accordance with each circuit unit.

10. The circuit system as set forth in claim 1, wherein at least the plurality of circuit units, the plurality of power supply selection circuits, and the control circuit are provided in one chip.
